(19) United States
(12) Patent Application Publication
(10) Pub. No.: US 2024/0093001 A1
(43) Pub. Date: Mar. 21, 2024

(54) RUBBER COMPOSITION FOR HOSE, TRANSMISSION OIL PIPE FOR AUTOMOBILE, AND METHOD FOR PRODUCING SAME

(71) Applicant: THE YOKOHAMA RUBBER CO., LTD., HIRATSUKA-SHI, KANAGAWA (JP)

(72) Inventor: Koki SUGIHARA, HIRATSUKA SHI, KANAGAWA (JP)

(21) Appl. No.: 18/269,887

(22) PCT Filed: Aug. 30, 2021
(86) PCT No.: PCT/JP2021/031762

§ 371 Date: Jun. 27, 2023

(30) Foreign Application Priority Data
Jan. 5, 2021 (JP) 2021-000484

(51) Int. Cl. C08K 5/205; C08K 3/04; C08K 5/10; C08K 5/3477; F16L 11/04; F16L 11/22

(52) U.S. Cl. CPC C08K 5/205; C08K 3/04; C08K 5/10; C08K 5/3477; F16L 11/04; F16L 11/22

(57) ABSTRACT

An object of the present invention is to provide a rubber composition for hoses that can be a cured product having excellent hardness and elongation at break through only primary crosslinking. The present invention is a rubber composition for hoses including a ternary copolymer including each constituent unit of ethylene, a (meth)acrylic acid ester, and a carboxyl group-containing monomer including a carboxyl group, hexamethylenediamine carbamate, diazabicycloundecene, carbon black, and a plasticizer, the rubber composition having a content of the carbon black of from 77 to 87 parts by mass per 100 parts by mass of the ternary copolymer, a transmission oil pipe for automobiles formed by using the rubber composition for hoses, and a method for producing the same.

### TECHNICAL FIELD

The present invention relates to a rubber composition for hoses, a transmission oil pipe for automobiles, and a method for producing the same.

### BACKGROUND ART

A known transmission oil cooler hose (TOC hose) has been used as a pipe for circulating transmission oil for automobiles.

The TOC hose is required to have heat resistance, oil resistance, cold resistance, caulking sealability in joining with a metal pipe (specifically, for rubber performance, high hardness and high elongation for obtaining flexibility), and the like.

To satisfy the above-mentioned heat resistance, oil resistance, and cold resistance, a rubber composition containing an AEM polymer (a ternary copolymer of ethylene, an acrylic acid ester, and a crosslinking monomer including a carboxyl group) and a crosslinking agent such as hexamethylenediamine is used for the TOC hose.

In the related art, to develop the characteristics and the like of the AEM polymer, a rubber composition containing the AEM polymer and the like has been typically subjected to secondary crosslinking, that is, a crosslinking step is performed in two stages to cure the rubber composition.

The two-stage crosslinking of the AEM polymer will be described with reference to the following reaction formula (schematic diagram) by taking, for example, a case where a rubber composition containing an AEM polymer represented by the following Formula (I) and hexamethylene diamine as a crosslinking agent is used and the rubber composition is subjected to two-stage crosslinking (the crosslinking step is performed in two stages).

In Formula (I) representing the AEM polymer, [CH₂CH ₂] represents a repeating unit of ethylene, [CR₁(CO₂R₂)CH₂] represents a repeating unit of a (meth)acrylic ester, [X(COOH)] represents a repeating unit of a carboxyl group-containing monomer including a carboxyl group, R₁ represents hydrogen or a methyl group, R₂ represents an ester residue, and o, p, and q each independently represent 1 or more. [X(COOH)] is not particularly limited as long as it is a repeating unit formed from a monomer including a carboxyl group and a group copolymerizable with ethylene and a (meth)acrylic acid ester.

In the following reaction formula, first, in primary crosslinking of the rubber composition (a first crosslinking step in the two-stage crosslinking), two amino groups of hexamethylene diamine react with carboxyl groups of the AEM polymer represented by Formula (I) intermolecularly or intramolecularly to form two amide bonds and water, and the AEM polymer can be crosslinked via residues of hexamethylene diamine through amide type crosslinking. The AEM polymer crosslinked through amide type crosslinking is shown with portions other than the amide type crosslinking being omitted.

Then, in the secondary crosslinking (a second crosslinking step in the two-stage crosslinking), each of the two amide bonds further reacts with another carboxyl group in the AEM polymer to form two imide bonds and water, and thus the AEM polymer can be crosslinked through imide type crosslinking.

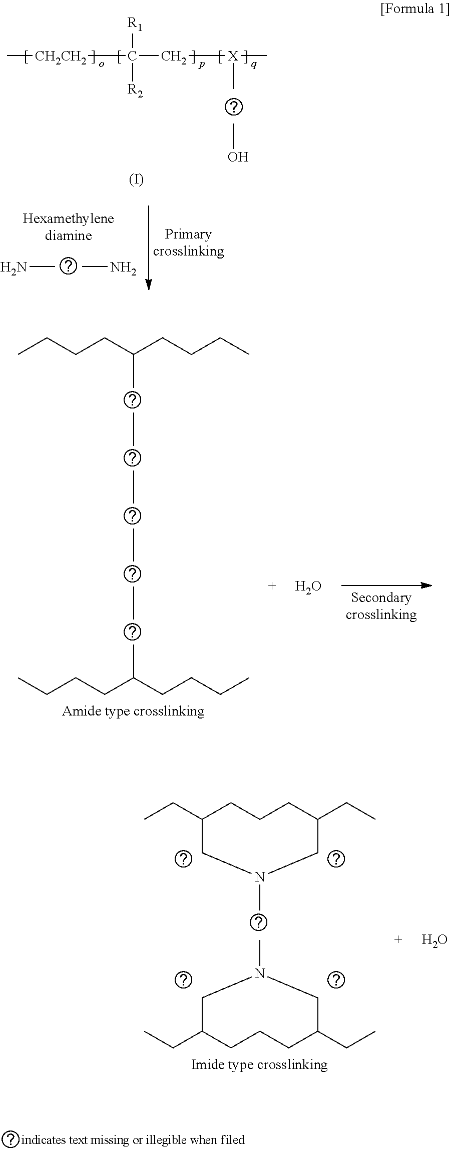

When a rubber composition containing the AEM polymer and the like is crosslinked through two-stage crosslinking, in practice, the primary crosslinking is performed under a condition of about 180° C. for about from 5 to 15 minutes, and after a cured product is taken out from the primary crosslinking step, the secondary crosslinking is performed under a condition of about from 170 to 180° C. for about from 2 to 4 hours.

In this manner, when a rubber composition containing the AEM polymer and the like is used, it is recommended to crosslink the composition through two-stage crosslinking to produce a hose or the like having properties and the like of the AEM polymer (for example, Patent Documents 1 and 2).

### CITATION LIST

### Patent Literature

Patent Document 1: JP S61-36586 A

Patent Document 2: WO 2019/087788

### SUMMARY OF INVENTION

### Technical Problem

However, the above-mentioned two-stage crosslinking usually requires a hot bath facility of about 180° C., a secondary crosslinking step, and the like, resulting in problems of cost and man-hours.

Under such circumstances, the inventor of the present invention, with reference to Patent Documents 1 and 2, prepared a rubber composition containing the AEM polymer and the like, crosslinked the rubber composition through only the primary crosslinking (that is, crosslinked the rubber composition through one-stage crosslinking), and evaluated the obtained cured product. As a result, it was found that such a cured product may have a hardness (type A durometer hardness) not falling within an appropriate range and/or may have a low elongation at break (Comparative Examples 1 to 3 and 5).

The fact that the cured product of the rubber composition has a hardness (type A durometer hardness) not falling within an appropriate range and/or has a low elongation at break as described above is considered to lead to a decrease in caulking sealability in joining a hose formed by using the rubber composition and a metal pipe.

An object of the present invention is to provide a rubber composition for a hose that can be formed into a cured product having excellent hardness and elongation at break through only primary crosslinking.

Another object of the present invention is to provide a transmission oil pipe for automobiles and a method for producing the same.

### Solution to Problem

As a result of intensive studies to solve the problem, the inventor of the present invention has found that a desired effect can be obtained by providing a rubber composition for hoses including a ternary copolymer including each constituent unit of ethylene, a (meth)acrylic acid ester, and a carboxyl group-containing monomer including a carboxyl group, hexamethylenediamine carbamate, diazabicycloundecene, carbon black, and a plasticizer, the rubber composition having a content of the carbon black of from 77 to 87 parts by mass per 100 parts by mass of the ternary copolymer including a carboxyl group derived from the carboxyl group-containing monomer, and has completed the present invention.

An embodiment of the present invention is based on the findings described above, and specifically solves the problems described above by the following configurations.

[1] A rubber composition for hoses, the rubber composition including a ternary copolymer including each constituent unit of ethylene, a (meth)acrylic acid ester, and a carboxyl group-containing monomer including a carboxyl group, hexamethylenediamine carbamate, diazabicycloundecene, carbon black, and a plasticizer,

the rubber composition having a content of the carbon black of from 77 to 87 parts by mass per 100 parts by mass of the ternary copolymer.

[2] The rubber composition for hoses according to [1], wherein

crosslinking is performed through only primary crosslinking, and

an elongation at break of a cured product after the primary crosslinking is 220% or more, and a type A durometer hardness of the cured product after the primary crosslinking is 75 or more and 85 or less.

[3] The rubber composition for hoses according to [1] or [2], wherein the carbon black includes a carbon black Cl having a nitrogen adsorption specific surface area of 38 m²/g or more and 45 m²/g or less and a DBP oil absorption of 100 ml/100 g or more and 130 ml/100 g or less.

[4] The rubber composition for hoses according to any one of [1] to [3], wherein the plasticizer includes an ester plasticizer.

[5] The rubber composition for hoses according to any one of [1] to [4], wherein a content of the plasticizer is 5 parts by mass or more and 15 parts by mass or less per 100 parts by mass of the ternary copolymer.

[6] The rubber composition for hoses according to any one of [1] to [5], wherein a content of the hexamethylenediamine carbamate is 1 part by mass or more and 1.6 parts by mass or less per 100 parts by mass of the ternary copolymer.

[7] The rubber composition for hoses according to any one of [1] to [6], wherein the rubber composition for hoses is used to form a transmission oil pipe for automobiles.

[8] A transmission oil pipe for automobiles formed by using the rubber composition for hoses according to any one of [1] to [6].

[9] The transmission oil pipe for automobiles according to [8], including an inner pipe and an outer pipe, wherein the inner pipe and the outer pipe are each independently formed by using the rubber composition for hoses.

[10] A method for producing a transmission oil pipe for automobiles, including producing a transmission oil pipe for automobiles by performing only primary crosslinking using the rubber composition for hoses according to any one of [1] to [6].

[11] The method for producing a transmission oil pipe for automobiles according to [10], wherein an elongation at break of a cured product of the rubber composition for hoses after the primary crosslinking is 220% or more, and a type A durometer hardness of the cured product of the rubber composition for hoses after the primary crosslinking is 75 or more and 85 or less.

[12] The method for producing a transmission oil pipe for automobiles according to or [10] or [11], wherein the rubber composition for hoses is independently used as a rubber composition for inner pipes and a rubber composition for outer pipes, the rubber composition for outer pipes is disposed on the rubber composition for inner pipes, and only the primary crosslinking is performed.

[13] The method for producing a transmission oil pipe for automobiles according to [12], wherein a reinforcing layer is further disposed between the rubber composition for inner pipes and the rubber composition for outer pipes.

### Advantageous Effects of Invention

The rubber composition for hoses of the present invention can be formed into a cured product having excellent hardness and elongation at break through only primary crosslinking.

The transmission oil pipe for automobiles of the present invention can have excellent hardness and elongation at break through only primary crosslinking.

According to the method for producing a transmission oil pipe for automobiles of the present invention, a transmission oil pipe for automobiles having excellent hardness and elongation at break can be produced through only primary crosslinking of the rubber composition for hoses of the present invention.

### DESCRIPTION OF EMBODIMENTS

Embodiments of the present invention will be described in detail below.

Note that in the present specification, value ranges indicated using “from . . . to . . . ” or “of . . . to . . . ” mean ranges including the value before “to” as a lower limit value and the value after “to” as an upper limit value.

In the present specification, unless otherwise indicated, a substance corresponding to each component can be used alone or in combination of two or more types thereof. In a case where a component includes two or more types of substances, content of component means the total content of the two or more types of substances.

In the present specification, the production method of each component is not limited unless otherwise noted. Examples of the method include a known method.

In the present specification, (meth)acryl represents acryl or methacryl.

In the present specification, the case where at least one of the hardness (type A durometer hardness) or the elongation at break of the cured product obtained through only primary crosslinking is improved may be referred to as “providing a superior effect of the present invention”.

### Rubber Composition for Hose

The rubber composition for hoses of the present invention (composition of the present invention) is a rubber composition for hoses including a ternary copolymer including each constituent unit of ethylene, a (meth)acrylic acid ester, and a carboxyl group-containing monomer including a carboxyl group, hexamethylenediamine carbamate, diazabicycloundecene, carbon black, and a plasticizer, the rubber composition having a content of the carbon black of from 77 to 87 parts by mass per 100 parts by mass of the ternary copolymer.

Each of the components included in the composition according to an embodiment of the present invention will be described in detail below.

### Ternary Copolymer

The ternary copolymer contained in the composition of the present invention includes each constituent unit of ethylene, a (meth)acrylic acid ester, and a carboxyl group-containing monomer including a carboxyl group (—COOH), and it is a ternary copolymer including the carboxyl group.

By including the ternary copolymer in the composition of the present invention, the resulting cured product has excellent heat resistance, oil resistance, and cold resistance.

The carboxyl group of the ternary copolymer may function as a crosslinking point to react with hexamethylenediamine carbamate described later.

The carboxyl group of the ternary copolymer is derived from a carboxyl group-containing monomer including a carboxyl group.

The form of the ternary copolymer is not particularly limited. Examples thereof include a random copolymer and a block copolymer.

### Ethylene

The ternary copolymer includes a constituent unit derived from ethylene.

Ethylene as a monomer forming a constituent unit of the ternary copolymer is not particularly limited.

The content of the constituent unit derived from ethylene in the ternary copolymer may be an amount obtained by subtracting the sum of the content of the constituent unit derived from the (meth)acrylic acid ester and the content of the constituent unit derived from the carboxyl group-containing monomer described later from the entire ternary copolymer (the total amount of the constituent units constituting the ternary copolymer).

### (Meth)acrylic Acid Ester

The ternary copolymer includes a constituent unit derived from a (meth)acrylic acid ester.

The (meth)acrylic acid ester as a monomer forming a constituent unit of the ternary copolymer is not particularly limited. Examples thereof include esters of (meth)acrylic acid and alkanol (a compound in which a hydroxy group is bonded to a linear, branched, or cyclic aliphatic hydrocarbon group or a combination thereof). The (meth)acrylic acid ester is preferably an ester of an alkanol having 1 to 8 carbon atoms (for example, a monoalkanol including one hydroxy group) and (meth)acrylic acid. Specific examples of the (meth)acrylic acid ester include methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, and cyclohexyl (meth)acrylate.

Of these, methyl (meth)acrylate is preferable from the perspective of providing a superior effect of the present invention.

Content of Constituent Unit Derived from (Meth)Acrylic Acid Ester

The content of the constituent unit derived from the (meth)acrylic acid ester in the ternary copolymer is not particularly limited, but it is preferably from 30 to 99 mass % in the ternary copolymer from the perspective of providing a superior effect of the present invention and providing improved weather resistance, heat resistance, and oil resistance of the resulting cured product.

### Carboxyl Group-Containing Monomer

The ternary copolymer includes a constituent unit of a carboxyl group-containing monomer including a carboxyl group.

The carboxyl group-containing monomer as a monomer forming a constituent unit of the ternary copolymer includes a carboxyl group, and includes a reactive group (excluding a carboxyl group) copolymerizable with ethylene and a (meth)acrylic acid ester.

Examples of the reactive group include an α, β-ethylenically unsaturated bond.

Examples of the carboxyl group-containing monomer include an α, β-ethylenically unsaturated monocarboxylic acid monomer having 3 to 12 carbon atoms, an α, β-ethylenically unsaturated dicarboxylic acid monomer having 4 to 12 carbon atoms, and a monoester monomer of an α, β-ethylenically unsaturated dicarboxylic acid having 4 to 12 carbon atoms and an alkanol having 1 to 8 carbon atoms.

Specific examples of the α, β-ethylenically unsaturated monocarboxylic acid monomer having 3 to 12 carbon atoms include acrylic acid, methacrylic acid, α-ethylacrylic acid, crotonic acid, and cinnamic acid.

Specific examples of the α, β-ethylenically unsaturated dicarboxylic acid monomer having 4 to 12 carbon atoms include butenedioic acids such as fumaric acid and maleic acid; itaconic acid; citraconic acid; and chloromaleic acid.

Specific examples of the monoester monomer of an α, β-ethylenically unsaturated dicarboxylic acid having 4 to 12 carbon atoms and an alkanol having 1 to 8 carbon atoms include butenedioic acid monochain alkyl esters such as monomethyl fumarate, monoethyl fumarate, mono-n-butyl fumarate, monomethyl maleate, monoethyl maleate, and mono-n-butyl maleate; butenedioic acid monoesters having an alicyclic structure such as monocyclopentyl fumarate, monocyclohexyl fumarate, monocyclohexenyl fumarate, monocyclopentyl maleate, monocyclohexyl maleate, and monocyclohexenyl maleate; and itaconic acid monoesters such as monomethyl itaconate, monoethyl itaconate, mono-n-butyl itaconate, and monocyclohexyl itaconate.

Content of Constituent Unit Derived from Carboxyl Group-Containing Monomer

The content of the constituent unit derived from the carboxyl group-containing monomer in the ternary copolymer is preferably from 0.5 to 10 mass % in the ternary copolymer from the perspective of providing a superior effect of the present invention.

The composition of the present invention contains the ternary copolymer as a rubber component. The rubber component contained in the composition of the present invention is preferably only the ternary copolymer from the perspective of providing a superior effect of the present invention.

When the composition of the present invention further contains a rubber component other than the ternary copolymer as a rubber component, the content of the ternary copolymer is preferably 90 mass % or more in the rubber component. Examples of the rubber component other than the ternary copolymer include a binary copolymer including each constituent unit of ethylene and a (meth)acrylic acid ester.

### Hexamethylenediamine Carbamate

Hexamethylenediamine carbamate (HMDAC) contained in the composition of the present invention is a compound represented by the following structural formula.

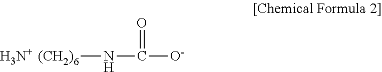

Hexamethylenediamine carbamate can react with the carboxyl group of the ternary copolymer.

Hexamethylenediamine carbamate can be, for example, decarboxylated (de-CO₂) to produce hexamethylenediamine. When each of the two amino groups of the hexamethylenediamine reacts with the carboxy group, the ternary copolymer can be crosslinked.

In the present invention, the hexamethylenediamine can react with the carboxyl group of the ternary copolymer to form an amide type crosslinking through only primary crosslinking (only one-stage crosslinking).

### Content of Hexamethylenediamine Carbamate

The content of hexamethylenediamine carbamate is preferably 1 part by mass or more and 1.6 parts by mass or less, and more preferably from 1.4 to 1.6 parts by mass per 100 parts by mass of the ternary copolymer from the perspective of providing a superior effect of the present invention.

### Diazabicycloundecene

Diazabicycloundecene (1,8-diazabicyclo[5.4.0]undec-7-ene, DBU) contained in the composition of the present invention can promote the above reaction of the ternary copolymer with hexamethylenediamine carbamate.

### Content of Diazabicycloundecene

The content of diazabicycloundecene is preferably from 0.1 to 10 parts by mass, and more preferably from 0.5 to 5 parts by mass per 100 parts by mass of the ternary copolymer from the perspective of providing a superior effect of the present invention.

### Carbon Black

The carbon black contained in the composition of the present invention is not particularly limited.

Examples of the carbon black include carbon blacks of Fast Extruding Furnace (FEF) grade, General Purpose Furnace (GPF) grade, and Semi-Reinforcing Furnace (SRF) grade.

### Carbon Black C1

The carbon black preferably contains a carbon black Cl having a nitrogen adsorption specific surface area of 38 m²/g or more and 45 m²/g or less and a dibutyl phthalate (DBP) oil absorption of 100 ml/100 g or more and 130 ml/100 g or less from the perspective of providing a superior effect of the present invention.

That the carbon black contains the carbon black C1 means that part or all of the carbon black is the carbon black C1.

From the perspective of providing a superior effect of the present invention, all of the carbon black is preferably the carbon black C1.

The nitrogen adsorption specific surface area of the carbon black may be measured in accordance with JIS K6217-2:2017.

The DBP oil absorption of the carbon black may be measured in accordance with JIS K6217-4:2017.

Examples of the carbon black C1 include a Fast Extruding Furnace (FEF) grade carbon black.

The carbon black C1 is preferably FEF grade carbon black from the perspective of providing a superior effect of the present invention.

### Content of Carbon Black

In the present invention, the content of carbon black is from 77 to 87 parts by mass per 100 parts by mass of the ternary copolymer.

By the content of carbon black being within the above range, the resulting cured product can have balanced elongation at break and hardness (type A durometer hardness) at an excellent level.

The content of carbon black is preferably from 82 to 85 parts by mass per 100 parts by mass of the ternary copolymer from the perspective of providing a superior effect of the present invention.

### Plasticizer

The plasticizer contained in the composition of the present invention is a substance capable of plasticizing or softening the ternary copolymer. The plasticizer does not include a processing aid to be described later.

### Ester Plasticizer

The plasticizer preferably contains an ester plasticizer from the perspective of providing a superior effect of the present invention.

The ester plasticizer is a compound having an ester bond derived from a carboxylic acid.

Examples of the ester plasticizer include ester compounds of aromatic hydrocarbon polycarboxylic acids such as a trimellitic acid plasticizer, a pyromellitic acid plasticizer, and a phthalic acid plasticizer; ester compounds of aliphatic hydrocarbon polycarboxylic acids such as an adipic acid ester plasticizer and a sebacic acid ester plasticizer; and polyester polymers.

The ester plasticizer may further have an ether bond in addition to the ester bond derived from a carboxylic acid. A plasticizer having an ether bond in addition to the ester bond derived from a carboxylic acid may be referred to as “ether-ester plasticizer”.

The plasticizer preferably includes an ether-ester plasticizer from the perspective of providing a superior effect of the present invention. The ether-ester plasticizer has one or more ether bonds and one or more ester bonds. The ether-ester plasticizer may have a plurality of ether bonds and a plurality of ester bonds.

Examples of the ether-ester plasticizer include polyesters of a polyoxyalkylene polyol and a monocarboxylic acid such as polyethylene glycol di(butanoic acid) ester, polyethylene glycol di(isobutanoic acid) ester, polyethylene glycol di(2-ethylbutyric acid) ester, polyethylene glycol di(2-ethylhexylic acid) ester, and polyethylene glycol di(decanoic acid) ester; and polyesters of a polycarboxylic acid and a monool having an ether bond, such as di(butoxyethanol) adipate, di(butyldiglycol) adipate (another name of the above compound is di(2-(2-butoxyethoxy)ethanol) adipate), di(butylpolyglycol) adipate (another name of the above compound is di(polyethylene glycol monobutyl ether) adipate), di(2-ethylhexyloxyethanol) adipate, di(2-ethylhexyldiglycol) adipate, di(2-ethylhexylpolyglycol) adipate, dioctoxyethanol adipate, di(octyldiglycol) adipate, and di(octylpolyglycol) adipate.

### Content of Plasticizer

The content of the plasticizer is preferably 5 parts by mass or more and 15 parts by mass or less, and more preferably from 8 to 12 parts by mass per 100 parts by mass of the ternary copolymer from the perspective of providing a superior effect of the present invention.

### Additives

The composition of the present invention may further contain additives, as necessary, as long as the effect of the present invention is not impaired.

Examples of the additives include polymers other than the ternary copolymer, processing aids, anti-aging agents, and fillers other than carbon black.

### Processing Aid

Examples of the processing aid include:

stearic acid;

polyoxyethylene alcohol ethers such as polyoxyethylene lauryl ether and polyoxyethylene oleyl ether;

polyoxyethylene alkylaryl ethers such as polyoxyethylene octylphenyl ether and polyoxyethylene nonylphenyl ether;

polypropylene glycol ethylene oxide adducts;

phosphoric acid esters such as alkyl phosphoric acid ester and polyoxyethylene alkyl ether phosphoric acid ester; and

alkylamines such as octadecylamine.

As the processing aid, stearic acid, polyoxyethylene alkyl ether phosphoric acid ester, and octadecylamine are preferably used in combination from the perspective of providing a superior effect of the present invention.

### Content of Processing Aid

The content of the processing aid (when two or more processing aids are used in combination, the total amount thereof) is preferably from 1 to 5 parts by mass per 100 parts by mass of the ternary copolymer.

### Method for Producing Composition of Present Invention

The production method of the composition of an embodiment of the present invention is not particularly limited. Usually, the composition of the present invention may be produced by mixing components other than hexamethylenediamine carbamate and diazabicycloundecene in a mixer such as a Banbury mixer, an intermixer, or a kneader, transferring the mixture to a roll or the like, adding hexamethylenediamine carbamate and diazabicycloundecene, and mixing them.

In the production method, the mixing is preferably performed under a condition that the ternary copolymer and hexamethylenediamine carbamate do not undergo a crosslinking reaction. In the production method, the mixing conditions when the ternary copolymer and hexamethylenediamine carbamate coexist are preferably, for example, 120° C. or less and 5 minutes or less.

### Crosslinking of Composition of Present Invention

### Primary Crosslinking

In the composition of the present invention, crosslinking may be performed through only primary crosslinking (crosslinking is performed only once; one-stage crosslinking).

According to the composition of the present invention, even when crosslinking is only primary crosslinking, the resulting cured product has excellent elongation at break and hardness (type A durometer hardness).

The crosslinking of the composition of the present invention (crosslinking step) is preferably performed through only primary crosslinking (only the step of one-stage crosslinking) from the perspective of being able to maintain the elongation at break and/or the hardness (type A durometer hardness) of the resulting cured product.

The composition of the present invention is preferably heated in the primary crosslinking.

### Heating Method

In the present invention, examples of the heating method in the primary crosslinking of the composition of the present invention include press heating, steam heating, and oven heating.

### Heating Temperature

In the present invention, as the crosslinking condition of the primary crosslinking of the composition of the present invention, the heating temperature is preferably from 140 to 160° C. from the perspective of providing a superior effect of the present invention.

In the present invention, when the composition of the present invention is crosslinked through only primary crosslinking, the heating temperature preferably does not exceed 160° C. from the perspective of being able to prevent the formation of imide bonds from amide type crosslinking in the reaction between the ternary copolymer and hexamethylenediamine carbamate and being able to maintain the hardness and elongation at break at an excellent level.

When the heating method is steam heating, the heating temperature is usually 160° C. or less. Thus, employing steam heating as the heating method is one of preferable modes from the perspective of the heating temperature not exceeding 160° C. as described above.

When the heating method is a method other than steam heating, the heating temperature can be set in each of the above-described methods. Thus, when a method other than steam heating is employed as the heating method, the heating temperature may be set to, for example, 160° C. or less.

### Crosslinking Time

In the present invention, the crosslinking time of the primary crosslinking of the composition of the present invention is preferably, for example, from 45 to 120 minutes from the perspective of providing a superior effect of the present invention and excellent productivity.

### Heating Temperature and Crosslinking Time

The combination of the heating temperature and the crosslinking time for the primary crosslinking of the composition of the present invention is preferably from 45 to 120 minutes under the condition of from 140 to 160° C. from the perspective of providing a superior effect of the present invention and excellent productivity.

When a rubber composition containing the AEM polymer is cured through two-stage crosslinking in the related art, it has been necessary to make the crosslinking time extremely long to form imide type crosslinking through secondary crosslinking unless the crosslinking is performed under a condition of 170° C. or more.

In this respect, in the present invention, the crosslinking step may be performed through only primary crosslinking, and amide type crosslinking can be formed through the primary crosslinking.

In addition, when the primary crosslinking is performed at a temperature lower than that in the related art, even when the primary crosslinking is performed for a time longer than that in the related art, it is possible to prevent the amide type crosslinking formed in the primary crosslinking from further reacting with another carboxy group to form an imide bond or an imide type crosslinking.

In the present invention, in the ternary copolymer after the primary crosslinking, crosslinking between the ternary copolymers (or intramolecular crosslinking) is presumed to be mainly amide type crosslinking. It is considered that the above-mentioned matter is proved from the fact that the cured product after the primary crosslinking balances excellent hardness and elongation at break in the present Examples.

In the ternary copolymer after the primary crosslinking, the ternary copolymer may have a side chain formed by bonding only one amino group in hexamethylenediamine to the ternary copolymer in addition to the amide type crosslinking.

The ternary copolymer after the primary crosslinking may further have an imide bond or an imide type crosslinking formed from the amide type crosslinking in addition to the amide type crosslinking.

It is technically impossible to prove by analysis or the like that the crosslinking between the ternary copolymers after the primary crosslinking is mainly amide type crosslinking, or how much the ternary copolymers after the primary crosslinking have the above-mentioned side chain, imide bond, or imide type crosslinking in addition to the amide type crosslinking. Thus, when “crosslinking” is defined for the composition of the present invention or the pipe of the present invention described later, it is considered by the applicant of the present invention to fall into the “impossible or impractical circumstances” in Examination Handbook 2205.

### Pressurization

Pressurization may be performed in the primary crosslinking. When pressure is applied during the primary crosslinking, the pressure may be from 2 to 4 MPa.

### Covering Material (Mold)

When the primary crosslinking is performed on the composition of the present invention, the composition of the present invention is preferably partially or entirely covered with a covering material (mold), and more preferably entirely covered with a covering material (mold) to prevent foaming. The same applies to the case where primary crosslinking is performed on the pipe of the present invention described later.

Examples of the covering material (mold) include polymethylpentene (trade name: TPX, Mitsui Chemicals, Inc.).

After crosslinking, the covering material (mold) may be peeled off from the cured product (hose or the like).

When the primary crosslinking of the composition of the present invention is performed under pressure (for example, press heating), foaming can be prevented by pressurization (pressing), and thus, a covering material (mold) may be used but does not have to be used.

In the present invention, the primary crosslinking does not include crosslinking between the ternary copolymer and hexamethylenediamine carbamate at the stage of producing the composition of the present invention.

For the composition of the present invention, performing crosslinking through only primary crosslinking (only one crosslinking step; one-stage crosslinking) means that the composition of the present invention after production is crosslinked in only one crosslinking step. When the composition of the present invention is crosslinked through only primary crosslinking, the term “only primary crosslinking” does not include two-stage crosslinking. Two-stage crosslinking refers to primary crosslinking followed by secondary crosslinking. Usually, the primary crosslinking and the secondary crosslinking differ in the modes of the heating method (for example, press heating for the primary crosslinking and oven heating for the secondary crosslinking), temperature conditions, and crosslinking time. In addition, in the two-stage crosslinking, usually, after the primary crosslinking, the temperature of the crosslinked product decreases, and the product is heated again in the secondary crosslinking.

In the present invention, the primary crosslinking does not include changing the heating temperature to two stages during one crosslinking step. For example, changing the heating temperature to a temperature of from 140 to 160° C. after maintaining the heating temperature at 100° C. or less during one crosslinking step is excluded from the primary crosslinking in the present invention.

In the present invention, during the primary crosslinking (one crosslinking step), the heating temperature is preferably constant within the above-mentioned heating temperature range, for example. During the primary crosslinking (one crosslinking step), when the crosslinking time is 90 minutes and the heating temperature is 157° C., the heating temperature is preferably kept constant at approximately 157° C. for the crosslinking time of 90 minutes.

In the present invention, for evaluation of “(Physical property of cured product)” described later, the composition of the present invention was subjected to press crosslinking for 90 minutes under conditions of 157° C. and a surface pressure of 3.0 MPa, and a cured product (2 mm thick) obtained after the crosslinking (primary crosslinking) was used.

### Physical Property of Cured Product

The elongation at break of the cured product obtained after the primary crosslinking of the composition of the present invention is preferably 220% or more, and the type A durometer hardness of the cured product is preferably 75 or more and 85 or less.

### Elongation at Break

The elongation at break is preferably from 230 to 320% from the perspective of providing a superior effect of the present invention.

In the present invention, the elongation at break was measured by performing a tensile test under conditions of 23° C.±2° C. and a tensile speed of 500 mm/min in accordance with JIS K6251:2017.

### Hardness (Type A Durometer Hardness)

The type A durometer hardness is preferably 76 or more and 83 or less, and more preferably from 80 to 83 from the perspective of providing a superior effect of the present invention.

In the present invention, an appropriate range of the hardness (type A durometer hardness) of the cured product after the primary crosslinking may be 76 or more and 83 or less.

In the present invention, the hardness (type A durometer hardness) was measured by performing a hardness measurement test under the condition of 23° C. using a type A durometer in accordance with JIS K6253-3:2012. In the evaluation of the hardness, three sheets of the cured product (2 mm thick) obtained as described above were stacked and used.

The cured product obtained through the primary crosslinking may be used as a rubber product (for example, a hose) as it is without being subjected to the secondary crosslinking thereafter.

The cured product obtained through the primary crosslinking may be subsequently subjected to the secondary crosslinking as long as the excellent elongation at break (specifically, 220% or more) and the hardness in an appropriate range (type A durometer hardness of from 75 to 85) of the cured product can be maintained in a balanced state.

The cured product obtained through the primary crosslinking is preferably not subjected to secondary crosslinking from the perspective of easily maintaining the cured product in a state in which the excellent elongation at break and hardness (type A durometer hardness) in an appropriate range are balanced and providing excellent productivity because of a small number of steps and the like.

In the present specification, when the secondary crosslinking is performed, the conditions of the secondary crosslinking are not particularly limited. As described above, the excellent elongation at break and hardness (type A durometer hardness) in an appropriate range of the cured product after the primary crosslinking are preferably maintained in a balanced state after the secondary crosslinking.

In the present specification, in the evaluation of the elongation at break and the hardness after the secondary crosslinking, the condition of the secondary crosslinking is that of the cured product being left under the condition of 180° C. for 240 minutes after the primary crosslinking.

### Rubber Composition for Hose

The composition of the present invention may be used to form a hose. Preferable modes of the hose include, for example, a transmission oil pipe for automobiles. A transmission oil pipe for automobiles is a pipe for circulating oil to a transmission mounted on an automobile.

### Transmission Oil Pipe for Automobile

The transmission oil pipe for automobiles of the present invention (the pipe of the present invention) is a transmission oil pipe for automobiles formed by using the rubber composition for hoses of the present invention.

The rubber composition for hoses used in the pipe of the present invention is not particularly limited as long as it is the rubber composition for hoses of the present invention.

### Inner Pipe and Outer Pipe

The pipe of the present invention includes, for example, a mode including an inner pipe and an outer pipe.

When the pipe of the present invention includes an inner pipe and an outer pipe, the inner pipe and/or the outer pipe is preferably formed by using the rubber composition for hoses, and the inner pipe and the outer pipe are more preferably each independently formed by using the rubber composition for hoses.

When the inner pipe and the outer pipe are each independently formed by using the rubber composition for hoses, both the rubber composition for hoses used for the inner pipe (rubber composition for inner pipe) and the rubber composition for hoses used for the outer pipe (rubber composition for outer pipe) may be the rubber composition for hoses of the present invention, and both may be the same or different from each other.

In the pipe of the present invention, the portion formed by using the composition of the present invention and obtained through primary crosslinking of the composition preferably has an elongation at break of 220% or more and a type A durometer hardness of 75 or more and 85 or less.

When the inner pipe is a cured product obtained after the primary crosslinking is performed on the composition of the present invention, the inner pipe (cured product obtained after the primary crosslinking is performed on the composition of the present invention) preferably has an elongation at break of 220% or more and a type A durometer hardness of 75 or more and 85 or less.

In the case where the outer pipe is a cured product obtained after the primary crosslinking is performed on the composition of the present invention as well, the outer pipe (cured product obtained after the primary crosslinking is performed on the composition of the present invention) preferably has an elongation at break of 220% or more and a type A durometer hardness of 75 or more and 85 or less.

The thickness of the inner pipe may be typically from 0.5 to 3 mm.

The thickness of the outer pipe may be typically from 0.5 to 3 mm.

The internal diameter of the pipe of the present invention may be typically from 8 to 20 mm.

The length of the pipe of the present invention may be typically from 0.1 to 200 m.

### Reinforcing Layer

The pipe of the present invention may further include, for example, a reinforcing layer in addition to the layer (or pipe) formed by the rubber composition for hoses of the present invention.

The pipe of the present invention may further include, for example, a reinforcing layer between the inner pipe and the outer pipe.

Examples of the material of the reinforcing layer include metals and fiber materials (e.g., polyamide and polyester). The reinforcing layer may be a surface-treated reinforcing layer.

Examples of the form of the reinforcing layer include those braided into a spiral structure and/or a braid structure.

The pipe of the present invention may be produced, for example, by a method for producing a transmission oil pipe for automobiles of the present invention to be described below.

### Method for Producing Transmission Oil Pipe for Automobile

The method for producing a transmission oil pipe for automobiles of the present invention (the production method of the present invention) is a method for producing a transmission oil pipe for automobiles including producing a transmission oil pipe for automobiles by performing only primary crosslinking using the rubber composition for hoses of the present invention.

The rubber composition for hoses used in the production method of the present invention is not particularly limited as long as the rubber composition is the rubber composition for hoses of the present invention.

A cured product (for example, the inner pipe or the outer pipe) of the rubber composition for hoses after the primary crosslinking preferably has an elongation at break of 220% or more and a type A durometer hardness of 75 or more and 85 or less.

Examples of the production method of the present invention include a method for producing a transmission oil pipe for automobiles including an inner pipe and an outer pipe by using the rubber composition for hoses as a rubber composition for inner pipes and/or a rubber composition for outer pipes, stacking the rubber composition for outer pipes on the rubber composition for inner pipes (at least one or both of the rubber composition for inner pipes and the rubber composition for outer pipes is the composition of the present invention), and performing only primary crosslinking on the obtained stack body.

The rubber composition for inner pipes may be first disposed on, for example, a mandrel (the same applies hereinafter).

When the pipe further includes a reinforcing layer (specifically, for example, when the reinforcing layer is further disposed between the rubber composition for inner pipes and the rubber composition for outer pipes), for example, the reinforcing layer is disposed on the rubber composition for inner pipes, the rubber composition for outer pipes is disposed on the reinforcing layer, and only primary crosslinking is performed thereon to produce a transmission oil pipe for automobiles including an inner pipe, the reinforcing layer, and an outer pipe.

Examples of the disposition of the rubber composition for inner pipes on the mandrel include extrusion molding. The disposition of the rubber composition for outer pipes is also the same as described above.

When the covering material (mold) is used, the covering material (mold) may be disposed on the rubber composition for outer pipes by, for example, extrusion molding. Examples of the covering material (mold) include the same as described above.

### Crosslinking

In the production method of the present invention, the crosslinking may be performed through only primary crosslinking (crosslinking is performed only once).

According to the production method of the present invention, the cured product obtained excellent elongation at break and hardness (type A durometer hardness) even when crosslinking is performed through only primary crosslinking.

The conditions for crosslinking in the method for producing a transmission oil pipe for automobiles of the present invention may be the same as those described above in “(Crosslinking of composition of present invention)” to “(Physical property of cured product)”.

According to the production method of the present invention, by using the composition of the present invention, it is possible to produce a transmission oil pipe for automobiles having excellent heat resistance, oil resistance, and cold resistance and having excellent elongation at break and hardness (type A durometer hardness) in an appropriate range without performing secondary crosslinking.

As described above, since the elongation at break is excellent and the hardness (type A durometer hardness) is in an appropriate range, it is presumed that in the transmission oil pipe for automobiles produced by the production method of the present invention, caulking sealability in joining with a metal pipe is improved.

The pipe of the present invention or the pipe produced by the production method of the present invention may be used as a pipe as it is without performing the secondary crosslinking. The pipe obtained through primary crosslinking may be subsequently subjected to secondary crosslinking as long as the excellent elongation at break (specifically, 220% or more) and the hardness in an appropriate range (type A durometer hardness of from 75 to 85) of the pipe can be maintained in a balanced state.

In the pipe of the present invention or the production method of the present invention, the secondary crosslinking is preferably not performed from the perspective of easily maintaining excellent elongation at break and hardness in an appropriate range (type A durometer hardness) in a balanced state and providing excellent productivity because of a small number of steps and the like.

### EXAMPLES

An embodiment of the present invention will be described below in detail by way of examples. However, an embodiment of the present invention is not limited to such examples.

### Production of Composition

The components shown in Table 1 below in the compositions (parts by mass) shown in the same table were used. The components other than hexamethylenediamine carbamate (Diak #1), diazabicycloundecene (ACT55), and the comparative crosslinking accelerator were mixed in a Banbury mixer under the condition of from 30 to 150° C., the mixture was transferred to a roll, hexamethylenediamine carbamate and diazabicycloundecene or the comparative crosslinking accelerator were added to the mixture, and the resulting material was mixed under the condition of 100° C. for 5 minutes to produce each composition.

### Crosslinking

Each composition prepared as described above was subjected to press crosslinking for 90 minutes under conditions of 157° C. using a press molding machine (surface pressure: 3.0 MPa) to obtain a crosslinked sheet (2 mm thick) as a cured product. The crosslinking is primary crosslinking, and secondary crosslinking was not performed. Since the primary crosslinking was performed under pressure as described above, each composition was not covered with a covering material.

### Evaluation

Tensile property

A dumbbell-shaped JIS No. 3 test piece was punched out from each crosslinked sheet produced as described above, and the tensile properties were evaluated with the obtained test piece. The results are shown in Table 1.
Tensile test

Using each test piece produced as described above, a tensile test was performed in accordance with JIS K6251:2017 under conditions of 23° C.±2° C. at a tensile speed of 500 mm/min, and tensile strength (Tb, unit: MPa), elongation at break (Eb, unit: %), and 100% modulus (M100, unit: MPa) were measured.
Evaluation criteria of elongation at break (Eb)

In the present invention, when the value of elongation at break was 220% or more, the elongation at break of the cured product was evaluated as “Good” (the column “Eb determination”). The greater over 220% the elongation at break is, the better the elongation at break of the cured product is.

On the other hand, when the elongation at break was less than 220%, the elongation at break of the cured product was evaluated as “Poor” (the column “Eb determination”).
Evaluation criteria of tensile strength

The tensile strength is preferably 12 MPa or more from the perspective of product strength.
Evaluation criteria of M100

The above is preferably 6.0 MPa or more from the perspective of caulking sealability in joining with a metal pipe.

### Hardness (Type A Durometer Hardness, HS)

Three crosslinked sheets obtained as described above were stacked and subjected to a hardness measurement test under the condition of 23° C. using a type A durometer in accordance with JIS K6253-3:2012 to measure the hardness (HS) of each test piece.
Evaluation criteria of hardness (type A durometer hardness) (HS)

In the present invention, when the hardness (type A durometer hardness) was from 75 to 85, the hardness (type A durometer hardness) of the cured product was evaluated as “Good” (the column “HS determination”).

When the hardness (type A durometer hardness) was less than 75 or more than 85, the hardness (type A durometer hardness) of the cured product was evaluated as “Poor” (the column “HS determination”).

It is considered that the cured product having excellent elongation at break and hardness (type A durometer hardness) leads to an improvement in caulking sealability when a hose formed by using the rubber composition and a metal pipe are joined.

In the present invention, caulking sealability in joining the hose and a metal pipe was considered mainly based on the results of the elongation at break and the hardness (type A durometer hardness) of the cured product. For the evaluation of the caulking sealability in joining with a metal pipe, the evaluation of the M100 is treated supplementarily.

TABLE 1

| | | Examples | Examples | Examples | Examples | Examples | Examples |
|---|---|---|---|---|---|---|---|
| | | 1 | 2 | 3 | 4 | 5 | 6 |
| Vamac Ultra IP (ternary AEM) | | 100.0 | 100.0 | 100.0 | 100.0 | 100.0 | 100.0 |
| FEF C.B | | 77.0 | 82.0 | 87.0 | 82.0 | 82.0 | 82.0 |
| Nocrac CD (anti-aging) | | 2.0 | 2.0 | 2.0 | 2.0 | 2.0 | 2.0 |
| Stearic acid (processing aid) | | 1.5 | 1.5 | 1.5 | 1.5 | 1.5 | 1.5 |
| RL210 (processing aid) | | 1.0 | 1.0 | 1.0 | 1.0 | 1.0 | 1.0 |
| Armeen 18D (processing aid) | | 0.5 | 0.5 | 0.5 | 0.5 | 0.5 | 0.5 |
| TP 759 (plasticizer) | | 10.0 | 10.0 | 10.0 | 5.0 | 10.0 | 10.0 |
| Diak #1 (HMDAC) crosslinking agent | | 1.4 | 1.4 | 1.4 | 1.4 | 1.2 | 1.0 |
| ACT 55 crosslinking accelerator | | 2.0 | 2.0 | 2.0 | 2.0 | 2.0 | 2.0 |
| Comparative crosslinking accelerator | | | | | | | |
| Total | | 195.4 | 200.4 | 205.4 | 195.4 | 200.2 | 200.0 |
| Tensile properties and | Tb (MPa) | 14.7 | 14.3 | 14.8 | 15.0 | 13.5 | 12.7 |
| hardness after primary | Eb (%) | 281 | 260 | 250 | 240 | 304 | 348 |
| crosslinking | Eb determination | Good | Good | Good | Good | Good | Good |
| Crosslinking | M100 (MPa) | 7.5 | 8.2 | 8.7 | 8.7 | 7.4 | 6.6 |
| conditions: | HS | 78 | 80 | 82 | 83 | 78 | 76 |
| Press 157° C. × 90 min | HS determination | Good | Good | Good | Good | Good | Good |

| | | Comparative | Comparative | Comparative | Comparative | Comparative |
|---|---|---|---|---|---|---|
| | | Example | Example | Example | Example | Example |
| | | 1 | 2 | 3 | 4 | 5 |
| Vamac Ultra IP (ternary AEM) | | 100.0 | 100.0 | 100.0 | 100.0 | 100.0 |
| FEF C.B | | 100.0 | 55.0 | 67.0 | 82.0 | 75.0 |
| Nocrac CD (anti-aging) | | 2.0 | 2.0 | 2.0 | 2.0 | 2.0 |
| Stearic acid (processing aid) | | 1.5 | 1.5 | 1.5 | 1.5 | 1.5 |
| RL210 (processing aid) | | 1.0 | 1.0 | 1.0 | 1.0 | 1.0 |
| Armeen 18D (processing aid) | | 0.5 | 0.5 | 0.5 | 0.5 | 0.5 |
| TP 759 (plasticizer) | | 10.0 | 10.0 | 10.0 | 0.0 | |
| Diak #1 (HMDAC) crosslinking agent | | 1.4 | 1.4 | 1.4 | 1.4 | 1.4 |
| ACT 55 crosslinking accelerator | | 2.0 | 2.0 | 2.0 | 2.0 | |
| Comparative crosslinking accelerator | | | | | | 4.0 |
| Total | | 205.4 | 173.4 | 185.4 | 190.4 | 185.4 |
| Tensile properties and | Tb (MPa) | 14.0 | 15.2 | 14.3 | 14.7 | 14.0 |
| hardness after primary | Eb (%) | 195 | 423 | 311 | 180 | 290 |
| crosslinking | Eb determination | Poor | Good | Good | Poor | Good |
| Crosslinking | M100 (MPa) | 9.5 | 3.9 | 5.9 | 10.0 | 7.2 |
| conditions: | HS | 87 | 65 | 74 | 84 | 72 |
| Press 157° C. × 90 min | HS determination | Poor | Poor | Poor | Good | Poor |

Details of the components indicated in Table 1 are as follows.

### Ternary Copolymer

Vamac Ultra IP (ternary AEM): Vamac (trade name) Ultra IP, available from DuPont (ternary copolymer of ethylene-acrylic acid ester-carboxyl group-containing monomer, having carboxyl group as a crosslinking point)

### Carbon Black

FEF C.B: FEF carbon black, N550, Trade name Niteron #10N, available from NIPPON STEEL Carbon Co., Ltd. N₂SA: 41 m²/g, DBP oil absorption: 120 ml/100 g

Since the carbon black Cl has a nitrogen adsorption specific surface area of 38 m²/g or more and 45 m²/g or less and a DBP oil absorption of 100 ml/100 g or more and 130 ml/100 g or less, it corresponds to the carbon black C1.
Nocrac CD (anti-aging): diphenylamine, trade name Nocrac CD, available from Ouchi Shinko Chemical Industrial Co., Ltd. Anti-aging agent Stearic acid (processing aid): Stearic acid 50S, available from Nisshin Chemical Co., Ltd.
RL 210 (processing aid): polyoxyethylene stearyl ether phosphoric acid, trade name Phosphanol RL-210, available from TOHO Chemical Industry Co., Ltd.
Armeen 18D (processing aid): octadecylamine, trade name Armeen 18D, available from AkzoNobel.

### Plasticizer

TP 759 (plasticizer): ether-ester plasticizer, trade name TP759, available from HallStar.

### Hexamethylenediamine Carbamate

Diak #1 (HMDAC) crosslinking agent: hexamethylene diamine carbamate, trade name Diak #1, available from DuPont.

### Diazabicycloundecene

ACT 55 crosslinking accelerator: diazabicycloundecene, trade name ACT 55, available from SAFIC ALCAN.
Comparative crosslinking accelerator: 1, 3-diphenylguanidine, trade name Sanceller D-G, available from Sanshin Chemical Industry Co., Ltd.

As is clear from the results shown in Table 1, Comparative Example 1 in which the content of carbon black was higher than a predetermined content had a poor elongation at break and a poor hardness (type A durometer hardness) after the primary crosslinking.

Comparative Examples 2 and 3 in which the content of carbon black was less than the predetermined content had a poor hardness (type A durometer hardness) after the primary crosslinking.

Comparative Example 4 containing no plasticizer had a poor elongation at break after the primary crosslinking.

Comparative Example 5 in which the content of carbon black was less than the predetermined range, no plasticizer was contained, and a crosslinking accelerator (guanidine compound) other than diazabicycloundecene was contained had a poor hardness (type A durometer hardness) after the primary crosslinking.

In contrast, the compositions of the present invention were able to form a cured product having excellent hardness (type A durometer hardness) and elongation at break through only primary crosslinking.

The cured products after the primary crosslinking obtained in Examples 1 to 6 were subjected to secondary crosslinking by placing them under the condition of 180° C. for 240 minutes, and the cured products after the secondary crosslinking in Examples 1 to 6 were measured for elongation at break and hardness (type A durometer hardness) in the same manner as described above. As a result, the cured products after the secondary crosslinking in Examples 2 to 4 had an elongation at break of less than 220% and a hardness (type A durometer hardness) of more than 85 and could not maintain excellent elongation at break and hardness (type A durometer hardness) in an appropriate range. The cured product after the secondary crosslinking in Example 5 had an elongation at break of less than 220% and could not maintain excellent elongation at break.

The cured products after the secondary crosslinking in Examples 1 and 6 were able to maintain excellent elongation at break and hardness in an appropriate range (type A durometer hardness) in a well-balanced manner.

1. A rubber composition for hoses, the rubber composition comprising:
a ternary copolymer comprising each constituent unit of ethylene, a (meth)acrylic acid ester, and a carboxyl group-containing monomer comprising a carboxyl group;
hexamethylenediamine carbamate;
diazabicycloundecene;
carbon black; and
a plasticizer,
the rubber composition having a content of the carbon black of from 77 to 87 parts by mass per 100 parts by mass of the ternary copolymer.

2. The rubber composition for hoses according to claim 1, wherein
crosslinking is performed through only primary crosslinking, and
an elongation at break of a cured product after the primary crosslinking is 220% or more, and a type A durometer hardness of the cured product after the primary crosslinking is 75 or more and 85 or less.

3. The rubber composition for hoses according to claim 1, wherein the carbon black comprises a carbon black C1 having a nitrogen adsorption specific surface area of 38 m²/g or more and 45 m²/g or less and a DBP oil absorption of 100 ml/100 g or more and 130 ml/100 g or less.

4. The rubber composition for hoses according to claim 1, wherein the plasticizer comprises an ester plasticizer.

5. The rubber composition for hoses according to claim 1, wherein a content of the plasticizer is 5 parts by mass or more and 15 parts by mass or less per 100 parts by mass of the ternary copolymer.

6. The rubber composition for hoses according to claim 1, wherein a content of the hexamethylenediamine carbamate is 1 part by mass or more and 1.6 parts by mass or less per 100 parts by mass of the ternary copolymer.

7. The rubber composition for hoses according to claim 1, wherein the rubber composition for hoses is used to form a transmission oil pipe for automobiles.

8. A transmission oil pipe for automobiles formed by using the rubber composition for hoses according to claim 1.

9. The transmission oil pipe for automobiles according to claim 8, comprising an inner pipe and an outer pipe, wherein the inner pipe and the outer pipe are each independently formed by using the rubber composition for hoses.

10. A method for producing a transmission oil pipe for automobiles, comprising producing a transmission oil pipe for automobiles by performing only primary crosslinking using the rubber composition for hoses according to claim 1.

11. The method for producing a transmission oil pipe for automobiles according to claim 10, wherein an elongation at break of a cured product of the rubber composition for hoses after the primary crosslinking is 220% or more, and a type A durometer hardness of the cured product of the rubber composition for hoses after the primary crosslinking is 75 or more and 85 or less.

12. The method for producing a transmission oil pipe for automobiles according to claim 10, wherein the rubber composition for hoses is independently used as a rubber composition for inner pipes and a rubber composition for outer pipes, the rubber composition for outer pipes is disposed on the rubber composition for inner pipes, and only the primary crosslinking is performed.

13. The method for producing a transmission oil pipe for automobiles according to claim 12, wherein a reinforcing layer is further disposed between the rubber composition for inner pipes and the rubber composition for outer pipes.
